(19) United States
(12) Patent Application Publication
(10) Pub. No.: US 2021/0110511 A1
(43) Pub. Date: Apr. 15, 2021

(54) IMAGE PROCESSING METHOD AND APPARATUS, COMPUTER DEVICE, AND COMPUTER STORAGE MEDIUM

(71) Applicant: BEIJING SENSETIME TECHNOLOGY DEVELOPMENT CO., LTD., Beijing (CN)

(72) Inventors: Mingyang HUANG, Beijing (CN); Wanzeng FU, Beijing (CN); Jianping SHI, Beijing (CN); Yi QU, Beijing (CN)

(21) Appl. No.: 17/128,613

(22) Filed: Dec. 21, 2020

Related U.S. Application Data
(63) Continuation of application No. PCT/CN2018/123976, filed on Dec. 26, 2018.

(30) Foreign Application Priority Data
Oct. 30, 2018 (CN) 201811278927.6

(51) Int. Cl. G06T 3/00; G06T 7/11; G06T 5/00; G06K 9/00; G06T 7/73; G06T 3/40

(52) U.S. Cl. CPC G06T 3/0012; G06T 7/11; G06T 5/005; G06T 2207/30201; G06T 7/73; G06T 3/40; G06T 2207/20021; G06K 9/00281

(57) ABSTRACT

An image processing method and apparatus, a computer device, and a computer storage medium are provided. The method includes: determining a target area to be processed in a face image; dividing the target area into N sub-areas, where N is an integer greater than 2; and respectively performing stretching/contraction transformation on a pixel point in each sub-area to obtain a processed image. A chin area in the face image is divided into a plurality of triangular sub-areas, and the chin is adjusted by using a stretching/contraction transformation algorithm.

### CROSS-REFERENCE TO RELATED APPLICATIONS

The present disclosure is a U.S. continuation application of International Application No. PCT/CN2018/123976, filed on Dec. 26, 2018, which claims priority to Chinese Patent Application No. 201811278927.6, filed to the Chinese Patent Office on Oct. 30, 2018. The disclosures of International Application No. PCT/CN2018/123976 and Chinese Patent Application No. 201811278927.6 are incorporated herein by reference in their entireties.

### BACKGROUND

In a common aesthetic idea, the chin and the lower jaw line are the center of gravity of a facial contour and may provide a beautiful facial contour line. An attractive chin may bring an overall aesthetic feeling to the upper jaw, the lip and the lower jaw. A conventional 2-Dimensional (2D) chin plasticity algorithm is mainly used for performing “stretching” operation on the chin of a person in a picture with the help of a face detection technology and a simple deformation algorithm, so as to achieve a simple “chin” fine-tuning effect.

### SUMMARY

Embodiments of the present disclosure relate to the field of computer visual communications, and relate to, but not limited to, an image processing method and apparatus, a computer device, and a computer storage medium.

The embodiments of the present disclosure provide an image processing method and apparatus, a computer device, and a computer storage medium.

The technical solutions of the embodiments of the present disclosure are implemented in the following manner.

One aspect of the embodiments of the present disclosure provides an image processing method. The method includes: determining a target area to be processed in a face image; dividing the target area into N sub-areas, where N is an integer greater than 2; and respectively performing stretching/contraction transformation on pixel points in each of the N sub-areas to obtain a processed image.

Another aspect of the embodiments of the present disclosure provides an image processing apparatus. The apparatus at least includes: a first determination module, a division module, and a stretching/contraction transformation module, where the first determination module is configured to determine a target area to be processed in a face image; the division module is configured to divide the target area into N sub-areas, N is an integer greater than or equal to 2; and the stretching/contraction transformation module is configured to respectively perform stretching/contraction transformation on pixel points in each of the N sub-areas to obtain a processed image.

Another aspect of the embodiments of the present disclosure provides a non-transitory computer storage medium, configured to store computer-readable instructions, where execution of the instructions by the processor causes the processor to perform the operations of the image processing method provided in the above aspect of the embodiments of the present disclosure.

Another aspect of the embodiments of the present disclosure provides a computer device, including a processor; and a memory for storing instructions executable by the processor, where execution of the instructions by the processor causes the processor to perform the operations of the image processing method provided in the above aspect of the embodiments of the present disclosure.

### BRIEF DESCRIPTION OF DRAWINGS

FIG. 1A is a schematic structural composition diagram of a network architecture according to the embodiments of the present disclosure;

FIG. 1B is a schematic flowchart for implementing an image processing method according to the embodiments of the present disclosure;

FIG. 1C is a network architecture diagram for implementing an image processing method according to the embodiments of the present disclosure;

FIG. 1D is another network architecture diagram for implementing an image processing method according to the embodiments of the present disclosure;

FIG. 2 is another schematic flowchart for implementing an image processing method according to the embodiments of the present disclosure;

FIG. 3 is still another schematic flowchart for implementing an image processing method according to the embodiments of the present disclosure;

FIG. 4 is a schematic diagram of a fitted broken line segment of a chin and a target chin contour according to the embodiments of the present disclosure;

FIG. 5 is a schematic diagram of dividing the chin into a plurality of triangular patches according to the embodiments of the present disclosure;

FIG. 6 is a structural composition diagram of one triangular patch according to the embodiments of the present disclosure;

FIG. 7A is a curve diagram of a stretching/contraction transformation function corresponding to stretching the chin according to the embodiments of the present disclosure;

FIG. 7B is a curve diagram of a stretching/contraction transformation function corresponding to contracting the chin according to the embodiments of the present disclosure;

FIG. 8 is a schematic diagram of performing stretching transformation on one triangular patch according to the embodiments of the present disclosure;

FIG. 9 is an effect drawing of stretching a chin area according to the embodiments of the present disclosure;

FIG. 10 is a schematic diagram of performing contraction transformation on one triangular patch according to the embodiments of the present disclosure;

FIG. 11 is an effect drawing of contracting a chin area according to the embodiments of the present disclosure;

FIG. 12 is a schematic structural composition diagram of an image processing apparatus according to the embodiments of the present disclosure;

FIG. 13 is a schematic structural composition diagram of a computer device according to the embodiments of the present disclosure.

### DETAILED DESCRIPTION

At present, the conventional 2D chin plasticity algorithm still has a great limitation. The effect of the deformation algorithm greatly depends on the accuracy of the face detection technology, and a fine deviation may lead to “plastic surgery failure”; a face detection model having high precision and dense feature points is time-consuming, which is unacceptable for photographing and real-time preview functions of a beautifying camera; the chin of a person has a complex stereoscopic shape; the conventional algorithm can only deal with a simple chin of a front face, and is difficult to deal with chins having different angles, sizes, and shapes. Therefore, 2D beautifying is difficult to make deformation of the five sense organs with stereoscopic impression, and simple deformation only involves simply stretching and pushing the chin contour, and cannot achieve a stereoscopic full effect.

In the embodiments of the present disclosure, by dividing a chin area in a face image into N continuous triangular sub-areas, and then adjusting the chin by using a preset stretching/contraction transformation algorithm so as to perform overall deformation on an area within a certain range around the chin contour, the negative effect caused by errors in feature points can be mitigated, the overall effect is more stable, and the adjusted chin is more beautiful.

In order to make the purpose, technical solutions and advantages of embodiments of the present disclosure more clear, the specific technical solutions of the invention are further described in details below with reference to the accompanying drawings in the embodiments of the present disclosure. The following embodiments are intended to illustrate the present disclosure, but are not intended to limit the scope of the present disclosure.

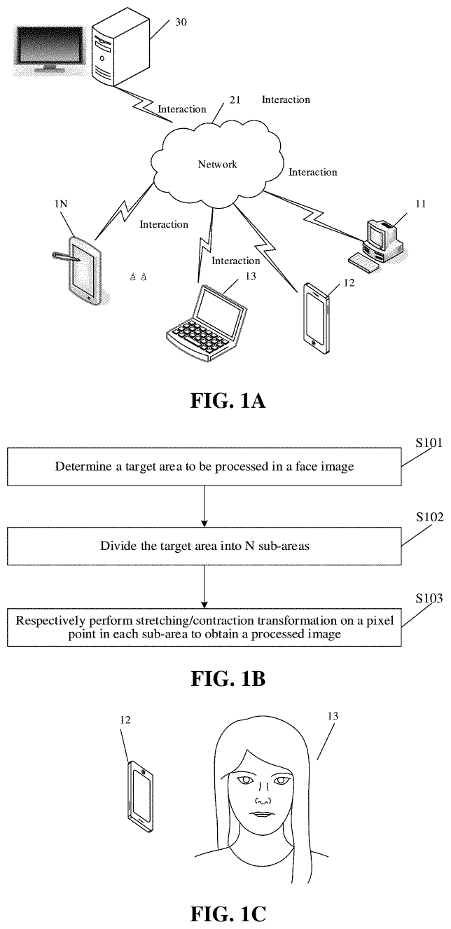

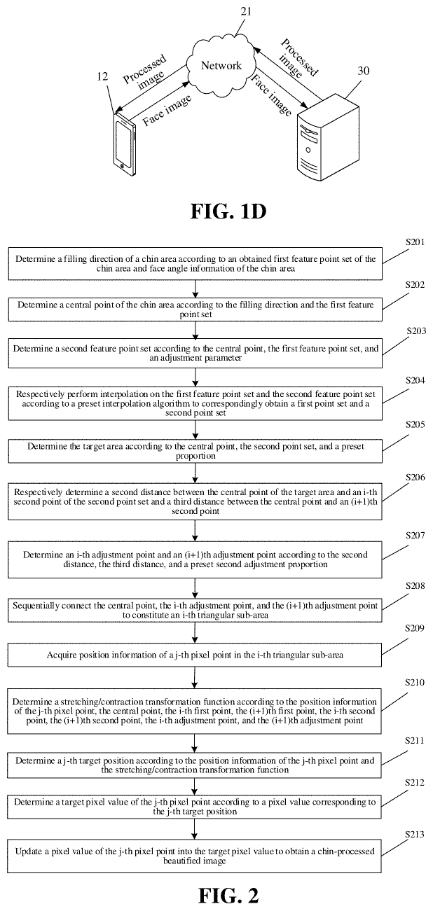

The embodiments provide a network architecture. FIG. 1A is a schematic structural composition diagram of a network architecture according to the embodiments of the present disclosure. As shown in FIG. 1A, the network architecture includes two or more computer devices 11 to 1N and a server 30, where the computer devices 11 to 1N interact with the server 30 by means of a network 21. The computer devices 11 to 1N are considered to be terminal devices in which an APP capable of using an image processing method provided in the embodiments of the present disclosure is installed. If a user inputs a face image to be processed into the APP, the APP transmits the face image to the server 30, then the server 30 processes the face image by using the image processing method according to the embodiments to obtain a processed image, and returns said image to the APP; and finally the processed image is displayed in the APP of the computer devices 11 to 1N. The computer device may be different types of computer devices having an information processing capability in a implementation process, for example, the computer device may include a cellphone, a tablet computer, a desktop computer, a personal digital assistant, a navigator, a digital telephone, a television and the like. According to the image processing method provided in the embodiments, the problems that 2D beautifying is difficult to make deformation of the five sense organs with stereoscopic impression, and simple deformation only involves simply stretching and pushing the chin contour, and cannot achieve a stereoscopic full effect can be effectively solved. The method is applied in a computer device. Functions implemented by the method are implemented by calling a program code by means of a processor in the computer device, and certainly, the program code may be stored in a computer storage medium. Hence, the computer device at least includes a processor and a storage medium.

The embodiments of the present disclosure provide an image processing method. FIG. 1B is a schematic flowchart for implementing the image processing method according to the embodiments of the present disclosure. As shown in FIG. 1B, the method includes the following operations.

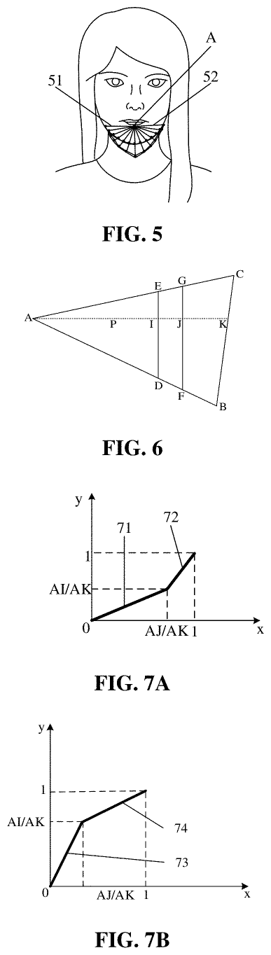

At operation S101, a target area to be processed in a face image is determined. Here, the determining the target area to be processed in the face image may be interpreted as: as shown in FIG. 5, using point A as a central point, and connecting the central point to end points at both sides of each of an actual contour and a target contour of the chin to form a sector area, where the sector area is the target area to be processed. The target area to be processed at least includes a chin area in the face image; the face image may be an image that is captured from any angle and includes a chin area, for example, a face image obtained by self-photographing or photographing from the side. Operation S101 may be implemented by a computer device. Furthermore, the computer device may be an intelligent terminal, for example, may be a mobile terminal device having a wireless communication capacity such as a mobile phone (cellphone), a tablet computer, and a laptop computer, or may be an intelligent terminal device inconvenient to move such as a desktop computer. The computer device is used for processing the target area to be processed.

At operation S102, the target area is divided into N sub-areas. Here, the N sub-areas may be N continuous triangular patches. Operation S102 may be interpreted as: dividing the target area into N continuous triangular patches, where N is an integer greater than or equal to 2; and a first sub-triangular patch having the same vertex angle and a second sub-triangular patch having the same vertex angle are embedded in each of the triangular patches. The dividing the target area into N continuous triangular patches includes: dividing the target area into N continuous triangular patches in a dimension of the contour of the target area, i.e., dividing the target area into N continuous triangular patches along the contour of the target area, and using line sections divided on the contour as bottom edges of the triangular patches. The dividing the target area into N continuous triangular patches may be interpreted as dividing the chin area in the face image into N continuous triangular patches. As shown in FIG. 5, the sector area consisting of the central point and points on the actual contour and the target contour of the chin is divided into N continuous triangular patches sequentially by using the central point A as a vertex point and using a connection line between two adjacent points on the target contour as a bottom edge. The bottom edge of the first sub-triangular patch is formed by two adjacent points on the actual contour of the chin area; and the second sub-triangular patch is formed by two adjacent points on the target contour of the chin area (i.e., a desired adjusted chin contour).

At operation S103, stretching/contraction transformation is respectively performed on pixel points in each sub-area to obtain a processed image. Respectively performing stretching/contraction transformation on pixel points in each sub-area may comprise respectively performing stretching transformation on pixel points in each sub-area, respectively performing contraction transformation on pixel points in each sub-area, or respectively performing contraction transformation on some pixel points in each sub-area and respectively performing stretching transformation on the remaining pixel points in each sub-area. Here, operation S103 may be interpreted as: according to position information of the vertex points of the first sub-triangular patch and the second sub-triangular patch in each of the triangular patches, performing stretching/contraction transformation on a pixel point in the corresponding triangular patch by using a preset stretching/contraction transformation algorithm to obtain a processed image. For each patch in the N triangular patches, stretching/contraction transformation is performed on a pixel point in the triangular patch by using the preset stretching/contraction transformation algorithm. The performing stretching/contraction transformation on the pixel point in the triangular patch by using the preset stretching/contraction transformation algorithm may be interpreted as replacing the pixel value of a pixel point in the first sub-triangular patch with the pixel value of a pixel point, corresponding to said pixel point in the first sub-triangular patch, in the second sub-triangular patch by using the preset stretching/contraction transformation algorithm. When the chin is stretched, the first sub-triangular patch is embedded in the second sub-triangular patch; and when the chin is contracted, the second sub-triangular patch is embedded in the first sub-triangular patch. For example, one of the plurality of triangular patches in the chin area is ABC, where A is the vertex angle, and BC is the bottom edge, and a first sub-triangular patch ADE and a second sub-triangular patch AFG are embedded in the triangular patch ABC; when the chin area needs to be stretched, replacing the pixel value of a pixel point in the area DEFG with the pixel value of a corresponding pixel point in the first sub-triangular patch ADE according to the preset stretching/contraction transformation algorithm is equivalent to moving the pixel value of the bottom edge DE to the bottom edge FG, thereby achieving the effect of stretching the chin area.

In the image processing method provided in the embodiments of the present disclosure, by dividing a chin area in a face image into N continuous triangular patches, and then adjusting the chin by using a preset stretching/contraction transformation algorithm so as to perform overall deformation on an area within a certain range around the chin contour, errors caused by performing deformation processing on the face can be reduced, so that the overall effect of face deformation is more stable, and the adjusted chin is more beautiful. In an implementation process, the image processing method provided in the embodiments may be locally implemented in a device, i.e., an application is installed in the device, when a face image including a chin area is acquired, the chin area is appropriately adjusted, and then the adjusted image is displayed to a user; and said method may also be implemented on a server, i.e., the device first obtains an image including a chin area and then sends the image to the server, and the server adjusts the chin area and then returns the adjusted face image (i.e., the processed image) to the device, and the device displays the adjusted face image to the user. When the image processing method provided in the embodiments is locally implemented in the device, the image processing method may be implemented when a client is installed in the device, i.e., an application capable of performing image processing is installed in the computer device. Thus, with reference to FIG. 1C, when the user performs photographing by using a device 12 in which an application capable of performing image processing by using the image processing method provided in the embodiments is installed, the application in the device 12 adjusts the chin area in an acquired face image of a user 13, and then the image displayed to the user is a face image after the chin is adjusted.

In some embodiments, the image processing method provided in the embodiments may also be implemented on a server. With reference to FIG. 1D, a device 12 sends an acquired face image including a chin area to a server, so that the server 30 receives the face image sent by the device 12 by means of a network 21. In this way, the server implements operation S101. In other words, if the method above is implemented on a server, the server receives a target area to be processed in a face image sent by the computer device, i.e., the server determines the target area to be processed in the face image; and then the server divides the target area into N continuous triangular patches and finally performs stretching/contraction transformation on a pixel point in the triangular patch by using a preset stretching/contraction transformation algorithm, so as to obtain a processed image. It can be known from the process above that the aforementioned process is executed on the server; and finally, the server may further send the processed image to the device, and in this way, the processed image is output to the user after the device receives the processed image.

In some embodiments, operation S103 includes the following operations. At operation S131, position information of a j-th pixel point in the i-th triangular sub-area is acquired. Here, the j-th pixel point may be any point in the triangular patch, and the position information at least includes a distance from the j-th pixel point to the vertex point of the triangular patch in which the j-th pixel point is located. At operation S132, a stretching/contraction transformation function is determined according to the position information of the j-th pixel point, a central point, an i-th first point, an (i+1)th first point, an i-th second point, an (i+1)th second point, an i-th adjustment point, and an (i+1)th adjustment point. Here, the central point is the vertex points of all triangular patches; the first point is a point in a first point set obtained by performing interpolation on a first feature point set according to a preset interpolation algorithm; the second point is obtained by adjusting a connection line between the first point and the central point according to a preset force parameter; when the chin needs to be stretched, the preset force parameter is 0 to 1, and the greater the preset force parameter is, the longer the chin is stretched; when the chin needs to be contracted, the preset force parameter is negative 1 to 0, and the smaller the preset force parameter is, the more the chin is contracted, i.e., the shorter the obtained contracted chin is. The adjustment point is obtained by adjusting a second connection line between the central point and the i-th second point by a second adjustment distance along a filling direction. For example, the i-th adjustment point is obtained by extending the second connection line between the central point and the i-th second point by the second adjustment distance along the filling direction (i.e., a stretching or contraction direction). At operation S133, a j-th target position is determined according to the position information of the j-th pixel point and the stretching/contraction transformation function. Here, an output value of the stretching/contraction transformation function as a proportion coefficient is multiplied by a sixth distance, so that a distance between the j-th target position and the central point is obtained; the sixth distance is a distance between the central point and a third intersection; the third intersection is obtained by extending a fourth connection line between the central point and the j-th pixel point along the filling direction to intersect the bottom edge of the triangular patch. At operation S134, a target pixel value of the j-th pixel point is determined according to a pixel value corresponding to the j-th target position. Here, the determining the target pixel value of the j-th pixel point according to the pixel value corresponding to the j-th target position includes two cases: one is in response to the coordinate value of the target position being an integer, determining the pixel value of the target position as the target pixel value of the j-th pixel point; and the other is in response to the coordinate value of the target position being not an integer, determining a pixel value corresponding to the target position according to a preset algorithm, and determining the pixel value corresponding to the target position as the target pixel value of the j-th pixel point. Here, if the coordinate value of the target position is not an integer, a pixel value corresponding to the target position is determined by using a bilinear interpolation algorithm. The target pixel value of the j-th pixel point is replaced with the pixel value corresponding to the j-th target position, i.e., the j-th pixel point is replaced with the j-th target position. Thus, when the chin needs to be stretched, because the j-th pixel point is below the j-th target position, replacing the pixel value of the j-th pixel point with the pixel value of the j-th target position is equivalent to moving the j-th pixel point backwards to a position where the j-th target position is located. For example, the j-th pixel point is a certain point between the target contour of the chin and the actual contour of the chin (i.e., a certain point between the bottom edge of the first sub-triangular patch and the bottom edge of the second sub-triangular patch); then the pixel value corresponding to the j-th pixel point may be a pixel value corresponding to the color of the neck, and the j-th target position shall be in front of the j-th pixel point, i.e., the j-th target position may be a pixel value corresponding to the color of the chin; the pixel value of the j-th pixel point is replaced with the pixel value of the j-th target position, i.e., the pixel value corresponding to the color of the neck in an area to be extended below the chin is replaced with the pixel value corresponding to the color of the chin, so that a chin stretching effect is achieved. When the chin needs to be contracted, the j-th pixel point is above the j-th target position. Therefore, replacing the pixel value of the j-th pixel point with the pixel value of the j-th target position is equivalent to moving the j-th pixel point forwards to the position where the j-th target position is located. For example, the j-th pixel point is a certain point between the target contour of the chin and the actual contour of the chin (i.e., a certain point between the bottom edge of the first sub-triangular patch and the bottom edge of the second sub-triangular patch); then the pixel value corresponding to the j-th pixel point is still a pixel value corresponding to the color of the chin, and the j-th target position shall be behind the j-th pixel point, i.e., the j-th target position may be a pixel value corresponding to the color of the neck; the pixel value of the j-th pixel point is replaced with the pixel value of the j-th target position, i.e., the pixel value corresponding to the color of the chin is replaced with the pixel value corresponding to the color of the neck below the chin, so that a chin contraction effect is achieved. At operation S135, the pixel value of the j-th pixel point is updated into the target pixel value to obtain a chin-processed beautified image. Here, the updating the pixel value of the j-th pixel point into the target pixel value may be interpreted as replacing the pixel value of the j-th pixel point with the target pixel value.

In the embodiments, stretching or contraction of the chin area in an original face image is implemented by replacing the pixel value of the corresponding pixel point with the pixel value of the target position.

The embodiments of the present disclosure provide an image processing method. FIG. 2 is another schematic flowchart for implementing the image processing method according to the embodiments of the present disclosure. As shown in FIG. 2, the method includes the following operations.

At operation S201, the filling direction of the chin area is determined according to the obtained first feature point set of the chin area and face angle information of the chin area. Here, the face angle information may be an angle by which the face deviates leftward from the front or an angle by which the face deviates rightward from the front in the face image; the first feature point set is feature points detected on the chin area according to a face detection algorithm, such as three feature points that are distributed at both sides and the bottom of the chin contour. The first feature point set is several feature points on the actual contour of the chin area detected by using the face detection algorithm.

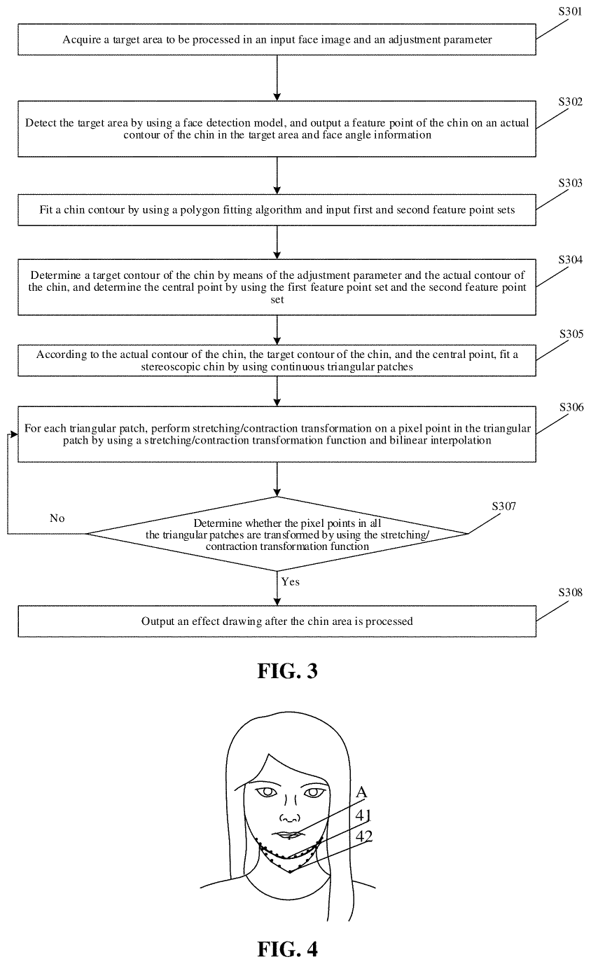

At operation S202, the central point of the chin area is determined according to the filling direction and the first feature point set. Here, the central point of the chin area is as shown in FIG. 4, and point A is the central point.

At operation S203, a second feature point set is determined according to the central point, the first feature point set, and an adjustment parameter. Here, a first feature point in the first feature point set is connected to the central point (the length of the connection line is a first distance); then a first adjustment proportion is determined according to an adjustment parameter, and the first distance is multiplied by the first adjustment proportion to obtain a first adjustment distance; finally an end point obtained by extending the first feature point by the first adjustment distance along the filling direction is determined as a corresponding second feature point (i.e., an end point obtained by stretching or shortening a first connection line between the central point and the first feature point by a length of the first adjustment distance along the filling direction); similarly, a point set corresponding to the first feature point set is obtained, where the point set is a second feature point set. When the chin area needs to be extended, the adjustment parameter is a value from 0 to 1, and the greater the value of the adjustment parameter is, the longer the chin area is extended; and when the chin area needs to be contracted, the adjustment parameter is a value from negative 1 to 0, and the smaller the adjustment parameter is, the more the chin area is shortened.

At operation S204, interpolation is respectively performed on the first feature point set and the second feature point set according to a preset interpolation algorithm to correspondingly obtain a first point set and a second point set. Here, the preset interpolation algorithm may relate to respectively performing interpolation on the actual contour and the target contour of the chin area according to the first feature point set and the second feature point set by using a polygonal fitting method (Catmull-Rom) to obtain the first point set and the second set point; as shown in FIG. 4, the first feature point set is a point set on an actual contour 41 of the chin area; and the second feature point set is a point set on a target contour 42 of the chin area.

At operation S205, the target area is determined according to the central point, the second point set, and a preset proportion. Here, the preset proportion is determined by a required stretching or shortening length; for example, when the chin area needs to be stretched, the preset proportion may be set as a number greater than 1. The central point is connected to each point in the second point set, the distance of the connection line is multiplied by the preset proportion, and the connection line is adjusted to obtain a point set having the same number of points as that in the second point set; the central point is connected to the leftmost point in the point set (i.e., a connection line 51), the central point is connected to the rightmost point in the point set, and starting from the connection line 51 in a counterclockwise direction, each point in the point set is connected until the connection line 52 is reached, and the area between the two lines is the target area. As shown in FIG. 5, the area between the connection line 51 and the connection line 52 is the target area.

At operation S206, a second distance between the central point of the target area and an i-th second point of the second point set and a third distance between the central point and an (i+1)th second point are respectively determined. Here, i=1, 2, . . . , N, and (N+1), the value of i is the total number of second points; and the second point is a point in the second point set. As shown in FIG. 6, the second distance between the central point and the i-th second point may be considered as a connection line AF between the central point A and a point F on the target contour of the chin, and then, the third distance between the central point and the (i+1)th second point is a connection line AG between the central point A and a point G that is on the target contour of the chin and is adjacent to the point F, and the bottom edge of the second sub-triangular patch AFG is FG.

At operation S207, an i-th adjustment point and an (i+1)th adjustment point are determined according to the second distance, the third distance, and a preset second adjustment proportion. Here, when the chin area needs to be stretched, the preset second adjustment proportion may be set as 1.1; the determining the i-th adjustment point and the (i+1)th adjustment point according to the second distance, the third distance, and the preset second adjustment proportion includes: determining a second adjustment distance and a third adjustment distance according to the second distance, the third distance, and the preset second adjustment proportion; determining an end point obtained by extending the i-th second point by the second adjustment distance along the filling direction as the i-th adjustment point, where the i-th adjustment point is on a second connection line between the central point and the i-th second point; and determining an end point obtained by extending the (i+1)th second point by the third adjustment distance along the filling direction as the (i+1)th adjustment point. As shown FIG. 5, AF is extended by the second adjustment distance along the filling direction to obtain a point B (i.e., the i-th adjustment point); and AG is extended by the second adjustment distance along the filling direction to obtain a point C (i.e., the (i+1) adjustment point).

At operation S208, the central point, the i-th adjustment point, and the (i+1)th adjustment point are sequentially connected to constitute an i-th triangular sub-area.

At operation S209, position information of a j-th pixel point in the i-th triangular sub-area is acquired. Here, the position information of the j-th pixel point at least includes a distance from the j-th pixel point to the central point, and as shown in FIG. 6, the j-th pixel point may be any point P in the triangular patch ABC.

At operation S210, the stretching/contraction transformation function is determined according to the position information of the j-th pixel point, the central point, the i-th first point, the (i+1)th first point, the i-th second point, the (i+1)th second point, the i-th adjustment point, and the (i+1)th adjustment point. Here, the stretching/contraction transformation function is determined by the central point and the j-th pixel point; and according to an obtained output result, the j-th target position is determined, so as to implement replacement of the pixel value of the j-th pixel point with the j-th target position, thereby achieving a chin stretching or shortening effect.

At operation S211, the j-th target position is determined according to the position information of the j-th pixel point and the stretching/contraction transformation function.

At operation S212, the target pixel value of the j-th pixel point is determined according to the pixel value corresponding to the j-th target position.

At operation S213, the pixel value of the j-th pixel point is updated into the target pixel value to obtain the chin-processed beautified image. Here, the updating the pixel value of the j-th pixel point into the target pixel value may be interpreted as replacing the pixel value of the j-th pixel point with the pixel value of the j-th target position.

In the embodiments, the chin area to be processed is first divided into a plurality of triangular patches, and then the pixel value of every point in each triangular patch is replaced, so as to achieve a chin stretching or shortening effect.

In some embodiments, operation S203, i.e., determining a second feature point set according to the central point, the first feature point set, and an adjustment parameter, includes the following operations. At operation S231, a first distance between the central point and a first feature point is determined. Here, the first feature point is a point in the first feature point set, and as shown in FIG. 6, the first distance is AD. At operation S232, a first adjustment proportion is determined according to the adjustment parameter. Here, when the chin needs to be stretched, the adjustment parameter is a positive number, and thus, the first adjustment proportion is a ratio greater than 0. At operation S233, a first adjustment distance is determined according to the first distance and the first adjustment proportion. At operation S234, an end point obtained by extending the first feature point by the first adjustment distance along the filling direction is determined as a corresponding second feature point. Here, as shown in FIG. 6, AD is adjusted by the first adjustment distance along the filling direction to obtain AF, and the point F is the second feature point. At operation S235, a second feature point corresponding to each first feature point in the first feature set is acquired to obtain the second feature point set.

In some embodiments, operation S207, i.e., determining an i-th adjustment point and an (i+1)th adjustment point according to the second distance, the third distance, and a preset second adjustment proportion, includes the following operations. At operation S271, a second adjustment distance and a third adjustment distance are determined according to the second distance, the third distance, and the preset second adjustment proportion. At operation S272, an end point obtained by extending the i-th second point by the second adjustment distance along the filling direction is determined as the i-th adjustment point, where a first point of the i-th adjustment point is on a second connection line between the central point and the i-th second point. At operation S273, an end point obtained by extending the (i+1)th second point by the third adjustment distance along the filling direction is determined as the (i+1)th adjustment point.

In some embodiments, operation S210, i.e., determining the stretching/contraction transformation function according to the position information of the j-th pixel point, the central point, the i-th first point, the (i+1)th first point, the i-th second point, the (i+1)th second point, the i-th adjustment point, and the (i+1)th adjustment point, includes the following operations. At operation A1, a fourth connection line between the central point and the j-th pixel point is extended along the filling direction, so as to intersect a connection line between the i-th first point and the (i+1)th first point at a first intersection, to intersect a connection line between the i-th second point and the (i+1)th second point at a second intersection, and to intersect a bottom edge of the triangular plane sub-area at a third intersection, where the bottom edge of the triangular plane sub-area is a connection line between the i-th adjustment point and the (i+1)th adjustment point. Here, as shown in FIG. 6, the first sub-triangular patch is ADE, the second sub-triangular patch is AFG, the first intersection is point I, the second intersection is point J, and the third intersection is point K. When the chin area is stretched, the first sub-triangular patch ADE is in the second sub-triangular patch AFG, i.e., the target contour of the chin is above the actual contour of the chin, so that the actual contour of the chin is stretched to the target contour to achieve a chin stretching effect. When the chin area is contracted, the first sub-triangular patch ADE is outside the second sub-triangular patch AFG, i.e., the target contour of the chin is below the actual contour of the chin, so that the actual contour of the chin is contracted to the target contour to achieve the a chin contraction effect. At operation A2, the stretching/contraction transformation function is determined according to a fourth distance, a fifth distance, and a sixth distance, where the fourth distance is a distance between the central point and the first intersection, the fifth distance is a distance between the central point and the second intersection, and the sixth distance is a distance between the central point and the third intersection. Operation A2, i.e., determining the stretching/contraction transformation function according to a fourth distance, a fifth distance, and a sixth distance, includes the following operations. At operation A21, a first ratio between the fourth distance and the sixth distance, and a second ratio between the fifth distance and the sixth distance are determined. At operation A22, a first coordinate is determined according to the first ratio and the second ratio. At operation A23, a linear equation of a connection line between the first coordinate and an origin coordinate is determined as a first piecewise function. At operation A24, a linear equation of a connection line between the first coordinate and a preset second coordinate is determined as a second piecewise function. At operation A25, the stretching/contraction transformation function is determined according to the first piecewise function and the second piecewise function.

In the embodiments, here, as shown in FIG. 6, in the triangular patch ABC, the fourth distance, the fifth distance, and the sixth distance are respectively AI, AJ, and AK. The stretching/contraction transformation function is a piecewise function, and the first piecewise function passes points (0, 0) and

$$( \frac{AJ}{A K} , \frac{A I}{A K} ) .$$

Therefore, the first piecewise function of the stretching/contraction transformation function is:

$$y = \frac{A I}{AJ} x ,$$

where x is a ratio of an input distance between the central point and the j-th pixel point in the triangular patch to AK (i.e., a ratio of a seventh distance to the sixth distance), and a distance between the j-th target position and the central point, i.e., an eighth distance, is determined according to the obtained output. As shown in FIG. 6, when the j-th pixel point is point P, if AP is less than or equal to AJ, the ratio of AP to AK (i.e., the sixth distance) is input to the first piecewise function. Therefore, the j-th target position corresponding to the point P is point P′ (if the chin area is stretched, the point P′ is in front of the point P; if the chin area is contracted, the point P′ is behind the point P), and the pixel value of the point P is replaced with the pixel value of the point P′, thereby achieving a chin stretching or contraction effect. The second piecewise function passes point

$$( \frac{AJ}{A K} , \frac{A I}{A K} )$$

and point (1, 1), and thus the second piecewise function is:

$$y = \frac{1 - \frac{AI}{A K}}{1 - \frac{A J}{A K}} ( x - 1 ) + 1.$$

When AJ>AI, a curve diagram of the first piecewise function and the second piecewise function is as shown in FIG. 7A, i.e., the first piecewise function is a curve 71, and the second piecewise function is a curve 72. When AJ<AI, the curve diagram of the first piecewise function and the second piecewise function is as shown in FIG. 7B, i.e., the first piecewise function is a curve 73, and the second piecewise function is a curve 74.

In some embodiments, operation A2 includes the following operations. At operation A26, a fourth distance and a fifth distance are determined to determine a first coordinate. At operation A27, a linear equation of a connection line between the first coordinate and an origin coordinate is determined as a first piecewise function. At operation A28, a preset second coordinate is determined according to the sixth distance. At operation A29, a linear equation of a connection line between the first coordinate and the preset second coordinate is determined as a second piecewise function. At operation A30, the stretching/contraction transformation function is determined according to the first piecewise function and the second piecewise function.

In some embodiments, operation S211 includes the following operations. At operation B1, a seventh distance between the j-th pixel point and the central point is determined according to the position information of the j-th pixel point. At operation B2, a third ratio between the seventh distance and the sixth distance is determined. At operation B3, the third ratio is used as an input of the stretching/contraction transformation function to obtain an output value. At operation B4, an eighth distance is determined according to the output value and the sixth distance, where the eighth distance is the distance between the j-th target position and the central point. At operation B5, the j-th target position is determined according to the eighth distance and the central point.

In some embodiments, operation S213 includes the following operations. At operation C1, in response to the coordinate value of the target position being an integer, the pixel value of the target position is determined as the target pixel value of the j-th pixel point. At operation C2, in response to the coordinate value of the target position being not an integer, a pixel value corresponding to the target position is determined according to the preset algorithm; and at operation C3, the pixel value corresponding to the target position is determined as the target pixel value of the j-th pixel point.

In the embodiments, polygonal fitting is further performed on the chin contour by using a Catmull-Rom polygonal fitting method based on a few feature points calibrated by a face detection model. Camera beautifying has extremely high requirements for the accuracy and execution efficiency of a detection model, and a polygon fitting method can effectively alleviate the performance pressure of the detection model. Meanwhile, the stretching/contraction transformation function provided in the embodiments has linear complexity, is more efficient, and can be adapted to the high-efficiency requirement of a camera real-time preview function for a beautifying algorithm. In addition, according to the embodiments, complex and various stereoscopic chins are fit by using triangular patches. The triangular patch fitting has functions of breaking up the whole into parts, simplifying the deformation process, and rapidly establishing a 3-Dimensional (3D) digital model, and can flexibly cope with chins having different angles, sizes and shapes. Moreover, according to the image processing method provided in the embodiments, the chin can be freely stretched and contracted, the deformation degree of freedom is higher, and the adaptation range is wider.

According to the image processing method provided in the embodiments of the present disclosure, when the chin in the face image is adjusted by using the method provided in the embodiments, in the adjustment process, the method has certain fault tolerance, so that overall deformation can be performed on an area within a certain range around the chin contour, the negative impact caused by errors in feature points can be mitigated, and the overall effect is more stable.

The image processing method provided in the embodiments can perform 3D “chin plasticity” beautifying on a photo of a face and includes the following operations. At the first operation, feature points of the chin are calibrated by using a face detection model, and the chin contour is fitted by using a Catmull-Rom polygonal fitting method; then, the stereoscopic chin is divided into continuous triangular patches according to a clockwise direction; and finally, stretching/contraction transformation is performed on each triangular patch by using a stretching/contraction transformation formula, so as to achieve a 3D “chin plasticity” effect. At the second operation, any polygon is fitted by the triangular patch to break up the whole into parts, and then the stretching/contraction transformation formula is separately used for each triangular patch, so that the implementation mode is simplified and the algorithm efficiency is greatly improved. At the third operation, the triangular patch is rapidly and flexibly deformed by using the stretching/contraction transformation formula. Here, the stretching/contraction transformation formula can also be applied to other image deformation fields based on a control point.

When the face image is processed by using the stretching/contraction transformation formula in the embodiments, a chin stretching effect can be achieved, and a chin contraction effect can also be achieved. The method is flexible and convenient.

FIG. 3 is still another schematic flowchart for implementing the image processing method according to the embodiments of the present disclosure. As shown in FIG. 3, the method includes the following operations.

At operation S301, a target area to be processed in an input face image and an adjustment parameter are acquired. Here, if the chin area needs to be stretched, the adjustment parameter is an integer, and a corresponding first adjustment proportion is a number from 0 to 1; if the chin area needs to be contracted, the adjustment parameter is a negative number, and the corresponding first adjustment proportion is a number from negative 1 to 0.

At operation S302, the target area is detected by using a face detection model, and a feature point of the chin on the actual contour of the chin in the target area and face angle information are output. Here, the feature point of the chin is a point in the first feature point set. An end point obtained by extending the first feature point by a first adjustment distance along a filling direction is determined as a corresponding second feature point. A process of obtaining a second feature point set according to the first feature point set includes three operations. At the first operation, a core zooming direction of “chin plasticity” is determined by using the face angle information and the feature point of the chin (i.e., determining the filling direction), and then one zooming center (i.e., the central point) of the “chin plasticity” is determined. At the second operation, the zooming center of the “chin plasticity” and the feature point of the chin are sequentially connected and adjusted, and according to the adjustment parameter, the position of the second feature point on the target contour of the chin area is determined by points on the line according to the first adjustment proportion. At the third operation, more points on the chin contour (including the actual chin contour and the target chin contour) are interpolated by using a Catmull-Rom polygon fitting method, the first feature point set and the second feature point set, and these points are connected to constitute a fitted broken line segment of the actual contour of the chin (consisting of the first point set) and a fitted broken line segment of the target contour of the chin (consisting of the second point set).

At operation S303, the chin contour is fitted by using the Catmull-Rom polygon fitting algorithm and the input first and second feature point sets. Here, the fitted broken line segment of the actual contour of the chin that consists of the first point set and the fitted broken line segment of the target contour of the chin that consists of the second point set are obtained after the chin contour is fitted.

At operation S304, the target contour of the chin is determined by means of the adjustment parameter and the actual contour of the chin, and the central point is determined by using the first feature point set and the second feature point set. Here, target contours in different angles are corrected by using an attribute of the face angle information detected by the face detection algorithm.

At operation S305, according to the actual contour of the chin, the target contour of the chin, and the central point, the stereoscopic chin is fitted by using continuous triangular patches. Here, the chin area is divided into a plurality of continuous triangular patches by inputting the fitted broken line segments of the actual contour of the chin and the target contour of the chin, and the zooming center of the “chin plasticity”. As shown in FIG. 5, the central point and the points on the target contour of the chin (i.e., the second point set) are sequentially connected, so that side edges of the triangular patches are obtained, and then the points on the target contour are sequentially connected, so that the bottom edges of the plurality of continuous triangular patches are obtained.

At operation S306, for each triangular patch, stretching/contraction transformation is performed on a pixel point in the triangular patch by using a stretching/contraction transformation function and bilinear interpolation. Here, a total of seven points are required to control the stretching/contraction transformation of the triangular patch, where three points A, B and C are three vertex points of the triangular patch, and the other four points D, E, F, and G are respectively points on broken lines corresponding to the original chin contour and the target chin contour. As shown in FIG. 6, the area ADE is the first sub-triangular patch, and the area AFG is the second sub-triangular patch.

At operation S307, whether the pixel points in all the triangular patches are transformed by using the stretching/contraction transformation function is determined. Here, if yes, the process proceeds to operation S308; and if not, the process returns to operation S306.

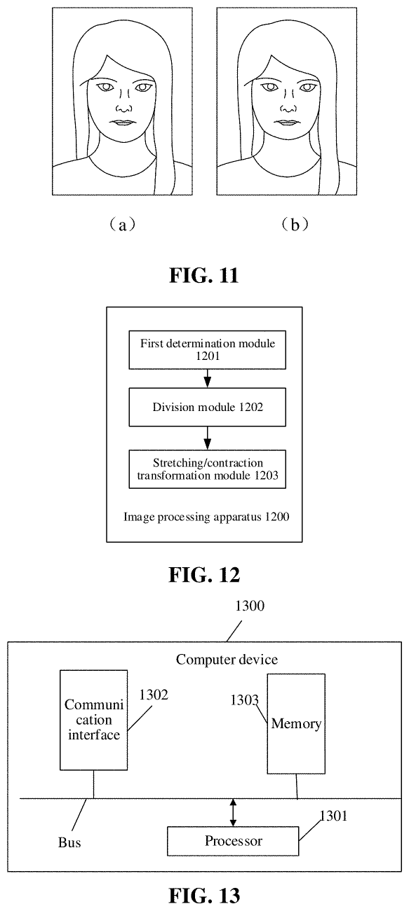

At operation S308, an effect drawing after the chin area is processed is output. Here, FIG. 9(a) is an original image, and FIG. 9(b) is an image after the chin area is stretched; FIG. 11(a) is an original image, and the FIG. 11(b) is an image after the chin area is contracted. It can be seen from FIGS. 9 and 11 that regardless of whether the chin area needs to be contracted or extended, the image processing method provided in the embodiments can obtain an effective and obvious processing result, and the processed chin is more in line with the public aesthetic. For performing stretching/contraction transformation on any point P in an input triangular patch, P′ to which the point P is mapped is obtained according to the stretching/contraction transformation function, so that the point P at a corresponding position of the output triangular patch takes the pixel value at the position of P′, thereby completing the displacement transformation from the point P′ to the point P. In the case that the coordinate of P′ is not an integer, a corresponding pixel value can be obtained by using a bilinear interpolation algorithm. In the triangular patch ABC, for each pixel point P in the triangular patch, the point P is connected and adjusted to intersect DE, FG, and BC at I, J, and K. Lengths of AP, AI, AJ, and AK are calculated, respectively (i.e., the fourth distance, the fifth distance, and the sixth distance). The stretching/contraction transformation function is a piecewise function, and the first piecewise function passes points (0, 0) and

$$( \frac{AJ}{A K} , \frac{A I}{A K} ) .$$

Therefore, the first piecewise function of the stretching/contraction transformation function is:

$$y = \frac{A I}{AJ} x$$

(when the chin area is stretched (using a function curve corresponding to AJ>AI, i.e., the function curve as shown in FIG. 7A), and as shown in FIG. 7A, a line segment 71 is the first piecewise function; and when the chin area is contracted (using a function curve corresponding to AJ<AI, i.e., the function curve as shown in FIG. 7B), as shown in FIG. 7B, a line segment 73 is the first piecewise function), where x is the ratio of the input distance between the central point and the j-th pixel point in the triangular patch to AK (i.e., the ratio of the seventh distance to the sixth distance), and the distance between the j-th target position and the central point, i.e., the eighth distance, is determined according to an obtained output. As shown in FIG. 6, when the j-th pixel point is the point P, if AP is less than or equal to AJ, the ratio of AP to AK (i.e., the sixth distance) is input to the first piecewise function. Therefore, the j-th target position corresponding to the point P is point P′ (if the chin area is stretched, the point P′ is in front of the point P; if the chin area is contracted, the point is behind the point P), and the pixel value of the point P is replaced with the pixel value of the point P′, thereby achieving a chin stretching or contraction effect. The second piecewise function passes point

$$( \frac{AJ}{A K} , \frac{A I}{A K} )$$

and point (1, 1), and thus the second piecewise function is:

$$y = \frac{1 - \frac{AI}{A K}}{1 - \frac{A J}{A K}} ( x - 1 ) + 1$$

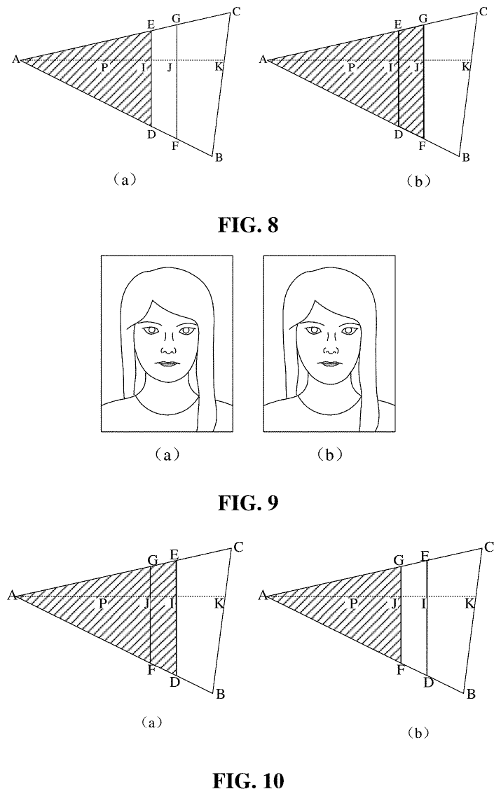

(when the chin area is stretched, as shown in FIG. 7A, a line segment 72 is the second piecewise function; and when the chin area is shortened, as shown in FIG. 7B, a line segment 74 is the second piecewise function). In this way, for any point P in the triangular patch, the corresponding pixel value at the position of the point P′ is taken, thereby completing stretching/contraction transformation. As shown in FIG. 8(a), when the chin area is stretched, the mapping point P′ obtained by the point P by means of the stretching/contraction function is in front of the point P. For example, when the point P is a point J, AJ is input to the function (i.e., the function curve as shown in FIG. 7A), and thus the point P′ is a point I; the pixel value of the point J is replaced with the pixel value of the point I; and an obtained result, as shown in FIG. 8(b), is that a pixel value of a blank area in area EDFG is replaced with a pixel value of a shadow area. As shown in FIG. 10(a), when the chin area is contracted, the mapping point P′ obtained by the point P by means of the stretching/contraction function is behind the point P. For example, when the point P is the point J, AJ is input to the function

$$y = \frac{A I}{AJ} x ,$$

and the point P′ is the point I; the pixel value of the point J is replaced with the pixel value of the point I; and an obtained result, as shown in FIG. 10(b), is that the pixel value of the shadow area is replaced with the pixel value of the blank area in the area EDFG. FIG. 11(a) is an original image, and FIG. 11(b) is an image after the chin area is contracted. By comparing the two images, it can be seen that the chin contraction effect is obvious, and the stretched curve is smooth. Thus, if the chin area of the user is not beautiful enough, the chin area can be adjusted according to actual conditions of the chin contour of the user, so that an image that is more in line with the public aesthetic and pleasing is obtained.

According to the image processing method provided in the embodiments, 3D deformation is performed by comprehensively using triangular patch fitting and the stretching/contraction transformation function to complete the “chin plasticity” function of the camera, so as to achieve the stereoscopic beautifying effect. The stereoscopic full five sense organs are in line with the aesthetics of oriental people. The 3D deformation can reshape the chin and the effect is more natural.

The embodiments of the present disclosure provide an image processing apparatus. FIG. 12 is a schematic structural composition diagram of the image processing apparatus according to the embodiments of the present disclosure. As shown in FIG. 12, the image processing apparatus 1200 includes: a first determination module 1201, a division module 1202, and a stretching/contraction transformation module 1203, where the first determination module 1201 is configured to determine a target area to be processed in a face image; the division module 1202 is configured to divide the target area into N sub-areas, where N is an integer greater than or equal to 2; and the stretching/contraction transformation module 1203 is configured to respectively perform stretching/contraction transformation on a pixel point in each sub-area to obtain a processed image.

In the embodiments of the present disclosure, the first determination module 1201 includes: a first determination unit configured to determine a filling direction of a chin area according to an obtained first feature point set of the chin area and face angle information of the chin area; a second determination unit configured to determine a central point of the chin area according to the filling direction and the first feature point set; a third determination unit configured to determine a second feature point set according to the central point, the first feature point set, and an adjustment parameter; an interpolation unit configured to respectively perform interpolation on the first feature point set and the second feature point set according to a preset interpolation algorithm to correspondingly obtain a first point set and a second point set; and a fourth determination unit configured to determine the target area according to the central point, the second point set, and a preset proportion.

In the embodiments of the present disclosure, the third determination unit includes: a first determination sub-unit configured to determine a first distance between the central point and a first feature point; a second determination sub-unit configured to determine a first adjustment proportion according to the adjustment parameter; a first adjustment distance determination unit configured to determine a first adjustment distance according to the first distance and the first adjustment proportion; a first adjustment unit configured to determine an end point obtained by extending the first feature point by the first adjustment distance along the filling direction as a second feature point corresponding to the first feature point; and a second feature point set determination sub-unit configured to acquire a second feature point corresponding to each first feature point in the first feature set to obtain the second feature point set.

In the embodiments of the present disclosure, the division module includes: a fifth determination unit configured to respectively determine a second distance between the central point of the target area and an i-th second point of the second point set and a third distance between the central point and an (i+1)th second point, where i=1, 2, . . . , N; a sixth determination unit configured to determine an i-th adjustment point and an (i+1)th adjustment point according to the second distance, the third distance, and a preset second adjustment proportion; and a connection unit configured to sequentially connect the central point, the i-th adjustment point, and the (i+1)th adjustment point to constitute an i-th triangular sub-area.

In the embodiments of the present disclosure, the sixth determination unit includes: a fourth determination sub-unit configured to determine a second adjustment distance and a third adjustment distance according to the second distance, the third distance, and the preset second adjustment proportion; a second adjustment unit configured to determine an end point obtained by extending the i-th second point by the second adjustment distance along the filling direction as the i-th adjustment point, where the i-th adjustment point is on a second connection line between the central point and the i-th second point; and a third adjustment unit configured to determine an end point obtained by extending the (i+1)th second point by the third adjustment distance along the filling direction as the (i+1)th adjustment point.

In the embodiments of the present disclosure, the stretching/contraction transformation module includes: a first acquisition unit configured to acquire position information of a j-th pixel point in the i-th triangular sub-area; a seventh determination unit configured to determine a stretching/contraction transformation function according to the position information of the j-th pixel point, the central point, the i-th first point, the (i+1)th first point, the i-th second point, the (i+1)th second point, the i-th adjustment point, and the (i+1)th adjustment point; an eighth determination unit configured to determine a j-th target position according to the position information of the j-th pixel point and the stretching/contraction transformation function; a ninth determination unit configured to determine a target pixel value of the j-th pixel point according to a pixel value corresponding to the j-th target position; and an update unit configured to update the pixel value of the j-th pixel point into the target pixel value, and obtain a chin-processed beautified image.

In the embodiments of the present disclosure, the seventh determination unit includes: a first extension sub-unit configured to extend a fourth connection line between the central point and the j-th pixel point along the filling direction, so as to intersect a connection line between the i-th first point and the (i+1)th first point at a first intersection, to intersect a connection line between the i-th second point and the (i+1)th second point at a second intersection, and to intersect a bottom edge of the triangular sub-area at a third intersection, where the bottom edge of the triangular sub-area is a connection line between the i-th adjustment point and the (i+1)th adjustment point; and a stretching/contraction sub-unit configured to determine the stretching/contraction transformation function according to a fourth distance, a fifth distance, and a sixth distance, where the fourth distance is a distance between the central point and the first intersection, the fifth distance is a distance between the central point and the second intersection, and the sixth distance is a distance between the central point and the third intersection.

In the embodiments of the present disclosure, the stretching/contraction sub-unit is further configured to: determine a first ratio between the fourth distance and the sixth distance, and a second ratio between the fifth distance and the sixth distance; determine a first coordinate according to the first ratio and the second ratio; determine a linear equation of a connection line between the first coordinate and an origin coordinate as a first piecewise function; determine a linear equation of a connection line between the first coordinate and a preset second coordinate as a second piecewise function; and determine the stretching/contraction transformation function according to the first piecewise function and the second piecewise function.

In the embodiments of the present disclosure, the eighth determination unit includes: a fifth determination sub-unit configured to determine a seventh distance between the j-th pixel point and the central point according to the position information of the j-th pixel point; a sixth determination sub-unit configured to determine a third ratio between the seventh distance and the sixth distance; an output sub-unit configured to use the third ratio as an input of the stretching/contraction transformation function to obtain an output value; a seventh determination sub-unit configured to determine an eighth distance according to the output value and the sixth distance, where the eighth distance is a distance between the j-th target position and the central point; and an eighth determination sub-unit configured to determine the j-th target position according to the eighth distance and the central point.

In the embodiments of the present disclosure, the ninth determination unit includes: a ninth determination sub-unit configured to: in response to the coordinate value of the target position being an integer, determine the pixel value of the target position as the target pixel value of the j-th pixel point; a tenth determination sub-unit configured to: in response to the coordinate value of the target position being not an integer, determine a pixel value corresponding to the target position according to a preset algorithm; and the tenth determination sub-unit configured to determine the pixel value corresponding to the target position as the target pixel value of the j-th pixel point.

It should be noted that the descriptions of the aforementioned apparatus embodiments are similar to the descriptions of the aforementioned method embodiments, and have beneficial effects similar to those of the method embodiments. For the technical details undisclosed in the apparatus embodiments of the present disclosure, please refer to the descriptions of the method embodiments of the present disclosure for understanding. In the embodiments of the present disclosure, the abovementioned instant messaging method may also be stored in a computer readable storage medium if being implemented in a form of a software functional module and sold or used as an independent product. Based on such an understanding, the technical solutions in the embodiments of the present disclosure or a part thereof contributing to the prior art may be essentially embodied in a form of software product. The computer software product is stored in one storage medium including several instructions so that one instant messaging device (which may be a terminal, a server, and the like) implements all or a part of the method in the embodiments of the present disclosure. Moreover, the preceding storage medium includes media having program codes stored such as a USB flash drive, a mobile hard disk drive, a Read Only Memory (ROM), a floppy disk, and an optical disc. In this way, the embodiments of the present disclosure are not limited to any combination of particular hardware and software.

Accordingly, the embodiments of the present disclosure provide a computer program product, including computer executable instructions, where the operations of the image processing method provided in the embodiments of the present disclosure can be implemented after the computer executable instructions are executed. Accordingly, the embodiments of the present disclosure provide a computer storage medium having computer executable instructions stored thereon, where the operations of the image processing method provided in the embodiments of the present disclosure can be implemented after the computer executable instructions are executed by a processor. Accordingly, the embodiments of the present disclosure provide a computer device. FIG. 13 is a schematic structural composition diagram of the computer device according to the embodiments of the present disclosure. As shown in FIG. 13, hardware entities of the computer device 1300 include: a processor 1301, a communication interface 1302, and a memory 1303, where the processor 1301 usually controls the overall operation of the computer device 1300. The communication interface 1302 can enable the computer device to communicate with other terminals or servers by means of a network. The memory 1303 is configured to store instructions executable by the processor 1301 and applications, further can cache data (for example, image data, audio data, voice communication data, and video communication data) that is to be processed or has been processed by the processor 1301 and modules in the computer device 1300, and can be implemented by a FLASH or a Random Access Memory (RAM).

The descriptions of the aforementioned instant computer device and storage medium embodiments are similar to the descriptions of the aforementioned method embodiments, and have beneficial effects similar to those of the method embodiments. For the technical details undisclosed in the instant messaging device and storage medium embodiments of the present disclosure, please refer to the descriptions of the method embodiments of the present disclosure for understanding. It should be understood that “one embodiment” or “an embodiment” mentioned throughout the description means that specific features, structures or properties related to the embodiments are included in at least one embodiment of the present disclosure. Therefore, “in one embodiment” or “in an embodiment” appearing throughout the whole description does not necessarily indicate the same embodiment. In addition, these specific features, structures or properties can be combined in one or more embodiments in any appropriate mode. It should be understood that in the embodiments of the present disclosure, the sequence numbers of the abovementioned processes do not imply an execution order, and the order of executing the processes should be determined by the functions and internal logics thereof, and should not constitute any limitation to the implementation processes in the embodiments of the present disclosure. The sequence numbers in the embodiments of the present disclosure are only for description and do not represent the quality of the embodiments. It should be noted that in this text, terms “comprise”, “include” or any other variants are intended to cover a non-exclusive inclusion, so that processes, methods, articles, or apparatuses including a series of elements not only include those elements but also include other elements that are not explicitly listed, or further include elements that are inherent to such processes, methods, articles, or apparatuses. In the case that there are no more limitations, an element defined by a sentence “including a . . . ” does not exclude the existence of other identical elements in the processes, methods, articles, or apparatuses including the element. It should be understood that the disclosed device and method in some embodiments provided in the present disclosure may be implemented by other modes. The device embodiments described above are merely exemplary. For example, the unit division is merely logical function division and may be actually implemented by other division modes. For example, a plurality of units or components may be combined or integrated into another system, or some features may be ignored or not performed. In addition, the displayed or discussed mutual couplings or direct couplings or communication connections among the components may be implemented by means of some interfaces. The indirect couplings or communication connections between the devices or units may be implemented in electronic, mechanical, or other forms. The units described as separate components may or may not be physically separate, and the components displayed as units may or may not be physical units, may be located at one position, or may be distributed on a plurality of network units. A part of or all of the units may be selected according to actual needs to achieve the objectives of the solutions of the embodiments. In addition, the functional units in the embodiments of the present disclosure may be integrated into one processing unit, or each of the units may exist as an independent unit, or two or more units are integrated into one unit, and the integrated unit may be implemented in the form of hardware, or may also be implemented in the form of a hardware and software functional unit.

Persons of ordinary skill in the art may understand that all or some operations for implementing the foregoing method embodiments are achieved by a program by instructing related hardware; the foregoing program can be stored in a computer readable storage medium; when the program is executed, operations including the foregoing method embodiments are executed. Moreover, the foregoing storage medium includes various media capable of storing program codes such as a mobile storage device, ROM, a magnetic disk, or an optical disk. Alternatively, the integrated unit of the present disclosure may also be stored in a computer readable storage medium if being implemented in a form of a software functional module and sold or used as an independent product. Based on such an understanding, the technical solutions in the embodiments of the present disclosure or a part thereof contributing to the prior art may be essentially embodied in a form of software product. The computer software product is stored in one storage medium including several instructions so that one computer device (which may be a personal computer, a server, and the like) implements all or a part of the method in the embodiments of the present disclosure. Moreover, the preceding storage medium includes media capable of storing program codes such as a mobile storage device, ROM, a floppy disk, and an optical disc.

The descriptions above are only specific implementations of this disclosure. However, the scope of protection of this disclosure is not limited thereto. Within the technical scope disclosed by this disclosure, any variation or substitution that can be easily conceived of by those skilled in the art should all fall within the scope of protection of this disclosure. Therefore, the scope of protection of the embodiments of the present disclosure should be defined by the scope of protection of the claims.

1. An image processing method, comprising:
determining a target area to be processed in a face image;
dividing the target area into N sub-areas, wherein N is an integer greater than or equal to 2; and
respectively performing stretching/contraction transformation on pixel points in each of the N sub-areas to obtain a processed image.

2. The image processing method according to claim 1, wherein the determining the target area to be processed in the face image comprises:
determining a filling direction of a chin area according to an obtained first feature point set of the chin area and face angle information of the chin area, wherein the first feature point set is a set of a plurality of first feature points;
determining a central point of the chin area according to the filling direction and the first feature point set;
determining a second feature point set according to the central point, the first feature point set, and an adjustment parameter;
respectively performing interpolation on the first feature point set and the second feature point set according to a preset interpolation algorithm to correspondingly obtain a first point set and a second point set; and
determining the target area according to the central point, the second point set, and a preset proportion.

3. The image processing method according to claim 2, wherein the determining the second feature point set according to the central point, the first feature point set, and the adjustment parameter comprises:
determining a first distance between the central point and a first feature point;
determining a first adjustment proportion according to the adjustment parameter;
determining a first adjustment distance according to the first distance and the first adjustment proportion;
determining an end point obtained by extending the first feature point by the first adjustment distance along the filling direction as a second feature point corresponding to the first feature point; and
acquiring a second feature point corresponding to each first feature point in the first feature point set to obtain the second feature point set.

4. The image processing method according to claim 2, wherein the dividing the target area into N sub-areas comprises:
respectively determining a second distance between the central point of the target area and an i-th second point of the second point set and a third distance between the central point and an (i+1)th second point, wherein i=1, 2, . . . , N;
determining an i-th adjustment point and an (i+1)th adjustment point according to the second distance, the third distance, and a preset second adjustment proportion; and
sequentially connecting the central point, the i-th adjustment point, and the (i+1)th adjustment point to constitute an i-th triangular sub-area.

5. The image processing method according to claim 4, wherein the determining the i-th adjustment point and the (i+1)th adjustment point according to the second distance, the third distance, and the preset second adjustment proportion comprises:
determining a second adjustment distance and a third adjustment distance according to the second distance, the third distance, and the preset second adjustment proportion;
determining an end point obtained by extending the i-th second point by the second adjustment distance along the filling direction as the i-th adjustment point, wherein the i-th adjustment point is on a second connection line between the central point and the i-th second point; and
determining an end point obtained by extending the (i+1)th second point by the third adjustment distance along the filling direction as the (i+1)th adjustment point.

6. The image processing method according to claim 4, wherein the respectively performing stretching/contraction transformation on the pixel points in each of the N sub-areas to obtain the processed image comprises:
acquiring position information of a j-th pixel point in the i-th triangular sub-area;
determining a stretching/contraction transformation function according to the position information of the j-th pixel point, the central point, the i-th first point, the (i+1)th first point, the i-th second point, the (i+1)th second point, the i-th adjustment point, and the (i+1)th adjustment point;
determining a j-th target position according to the position information of the j-th pixel point and the stretching/contraction transformation function;
determining a target pixel value of the j-th pixel point according to a pixel value corresponding to the j-th target position; and
updating a pixel value of the j-th pixel point into the target pixel value to obtain a chin-processed beautified image.

7. The image processing method according to claim 6, wherein the determining the stretching/contraction transformation function according to the position information of the j-th pixel point, the central point, the i-th first point, the (i+1)th first point, the i-th second point, the (i+1)th second point, the i-th adjustment point, and the (i+1)th adjustment point comprises:
extending a fourth connection line between the central point and the j-th pixel point along the filling direction, so as to intersect a connection line between the i-th first point and the (i+1)th first point at a first intersection, to intersect a connection line between the i-th second point and the (i+1)th second point at a second intersection, and to intersect a bottom edge of the triangular sub-area at a third intersection, wherein the bottom edge of the triangular sub-area is a connection line between the i-th adjustment point and the (i+1)th adjustment point; and
determining the stretching/contraction transformation function according to a fourth distance, a fifth distance, and a sixth distance, wherein the fourth distance is a distance between the central point and the first intersection, the fifth distance is a distance between the central point and the second intersection, and the sixth distance is a distance between the central point and the third intersection.

8. The image processing method according to claim 7, wherein the determining the stretching/contraction transformation function according to the fourth distance, the fifth distance, and the sixth distance comprises: determining a first ratio between the fourth distance and the sixth distance, and a second ratio between the fifth distance and the sixth distance; determining a first coordinate according to the first ratio and the second ratio; determining a linear equation of a connection line between the first coordinate and an origin coordinate as a first piecewise function; determining a linear equation of a connection line between the first coordinate and a preset second coordinate as a second piecewise function; and determining the stretching/contraction transformation function according to the first piecewise function and the second piecewise function.

9. The image processing method according to claim 6, wherein the determining the j-th target position according to the position information of the j-th pixel point and the stretching/contraction transformation function comprises: determining a seventh distance between the j-th pixel point and the central point according to the position information of the j-th pixel point; determining a third ratio between the seventh distance and the sixth distance; using the third ratio as an input of the stretching/contraction transformation function to obtain an output value; determining an eighth distance according to the output value and the sixth distance, wherein the eighth distance is a distance between the j-th target position and the central point; and determining the j-th target position according to the eighth distance and the central point.

10. The image processing method according to claim 6, wherein the determining the target pixel value of the j-th pixel point according to the pixel value corresponding to the j-th target position comprises: in response to the coordinate value of the target position being an integer, determining the pixel value of the target position as the target pixel value of the j-th pixel point; and in response to the coordinate value of the target position being not an integer, determining a pixel value corresponding to the target position according to a preset algorithm, and determining the pixel value corresponding to the target position as the target pixel value of the j-th pixel point.

11. A computer device, comprising:
a processor; and
a memory for storing instructions executable by the processor;
wherein execution of the instructions by the processor causes the processor to perform the following operations:
determining a target area to be processed in a face image;
dividing the target area into N sub-areas, wherein N is an integer greater than or equal to 2; and
respectively performing stretching/contraction transformation on pixel points in each of the N sub-areas to obtain a processed image.

12. The computer device according to claim 11, wherein the determining the target area to be processed in the face image comprises: comprises:
determining a filling direction of a chin area according to an obtained first feature point set of the chin area and face angle information of the chin area, wherein the first feature point set is a set of a plurality of first feature points;
determining a central point of the chin area according to the filling direction and the first feature point set;
a determining a second feature point set according to the central point, the first feature point set, and an adjustment parameter;
respectively performing interpolation on the first feature point set and the second feature point set according to a preset interpolation algorithm to correspondingly obtain a first point set and a second point set; and
determining the target area according to the central point, the second point set, and a preset proportion.

13. The computer device according to claim 12, wherein the determining the second feature point set according to the central point, the first feature point set, and the adjustment parameter comprises:
determining a first distance between the central point and a first feature point;
determining a first adjustment proportion according to the adjustment parameter;
determining a first adjustment distance according to the first distance and the first adjustment proportion;
determining an end point obtained by extending the first feature point by the first adjustment distance along the filling direction as a second feature point corresponding to the first feature point; and
acquiring a second feature point corresponding to each first feature point in the first feature point set to obtain the second feature point set.

14. The computer device according to claim 11, wherein the dividing the target area into N sub-areas comprises:
respectively determining a second distance between the central point of the target area and an i-th second point of the second point set and a third distance between the central point and an (i+1)th second point, wherein i=1, 2, . . . , N;
determining an i-th adjustment point and an (i+1)th adjustment point according to the second distance, the third distance, and a preset second adjustment proportion; and
sequentially connecting the central point, the i-th adjustment point, and the (i+1)th adjustment point to constitute an i-th triangular sub-area.

15. The computer device according to claim 14, wherein the determining the i-th adjustment point and the (i+1)th adjustment point according to the second distance, the third distance, and the preset second adjustment proportion comprises:
determining a second adjustment distance and a third adjustment distance according to the second distance, the third distance, and the preset second adjustment proportion;
determining an end point obtained by extending the i-th second point by the second adjustment distance along the filling direction as the i-th adjustment point, wherein the i-th adjustment point is on a second connection line between the central point and the i-th second point; and
determining an end point obtained by extending the (i+1)th second point by the third adjustment distance along the filling direction as the (i+1)th adjustment point.

16. The computer device according to claim 11, wherein the respectively performing stretching/contraction transformation on the pixel points in each of the N sub-areas to obtain the processed image comprises:
acquiring position information of a j-th pixel point in the i-th triangular sub-area;
determining a stretching/contraction transformation function according to the position information of the j-th pixel point, the central point, the i-th first point, the (i+1)th first point, the i-th second point, the (i+1)th second point, the i-th adjustment point, and the (i+1)th adjustment point;
determining a j-th target position according to the position information of the j-th pixel point and the stretching/contraction transformation function;
determining a target pixel value of the j-th pixel point according to a pixel value corresponding to the j-th target position; and
updating a pixel value of the j-th pixel point into the target pixel value to obtain a chin-processed beautified image.

17. The computer device according to claim 16, wherein the determining the stretching/contraction transformation function according to the position information of the j-th pixel point, the central point, the i-th first point, the (i+1)th first point, the i-th second point, the (i+1)th second point, the i-th adjustment point, and the (i+1)th adjustment point comprises:
extending a fourth connection line between the central point and the j-th pixel point along the filling direction, so as to intersect a connection line between the i-th first point and the (i+1)th first point at a first intersection, to intersect a connection line between the i-th second point and the (i+1)th second point at a second intersection, and to intersect a bottom edge of the triangular sub-area at a third intersection, wherein the bottom edge of the triangular sub-area is a connection line between the i-th adjustment point and the (i+1)th adjustment point; and
determining the stretching/contraction transformation function according to a fourth distance, a fifth distance, and a sixth distance, wherein the fourth distance is a distance between the central point and the first intersection, the fifth distance is a distance between the central point and the second intersection, and the sixth distance is a distance between the central point and the third intersection.

18. The computer device according to claim 17, wherein the determining the stretching/contraction transformation function according to the fourth distance, the fifth distance, and the sixth distance comprises:
determining a first ratio between the fourth distance and the sixth distance, and a second ratio between the fifth distance and the sixth distance; determining a first coordinate according to the first ratio and the second ratio; determining a linear equation of a connection line between the first coordinate and an origin coordinate as a first piecewise function; determining a linear equation of a connection line between the first coordinate and a preset second coordinate as a second piecewise function; and determining the stretching/contraction transformation function according to the first piecewise function and the second piecewise function.

19. The computer device according to claim 16, wherein the determining the j-th target position according to the position information of the j-th pixel point and the stretching/contraction transformation function comprises:
determining a seventh distance between the j-th pixel point and the central point according to the position information of the j-th pixel point;
determining a third ratio between the seventh distance and the sixth distance;
using the third ratio as an input of the stretching/contraction transformation function to obtain an output value;
determining an eighth distance according to the output value and the sixth distance, wherein the eighth distance is a distance between the j-th target position and the central point; and
determining the j-th target position according to the eighth distance and the central point.

20. A non-transitory computer storage medium, configured to store computer-readable instructions, wherein execution of the instructions by the processor causes the processor to perform the following operations:
determining a target area to be processed in a face image;
dividing the target area into N sub-areas, wherein N is an integer greater than or equal to 2; and
respectively performing stretching/contraction transformation on a pixel points in each of the N sub-areas to obtain a processed image.
